(19) United States
(12) Patent Application Publication
(10) Pub. No.: US 2025/0177992 A1
(43) Pub. Date: Jun. 5, 2025

(54) Pre-Shredder

(71) Applicant: Talleres ZB, S.A., Rentería (ES)

(72) Inventor: Mikel Macías Martín, Rentería (ES)

(21) Appl. No.: 18/845,115

(22) PCT Filed: Mar. 9, 2023
(86) PCT No.: PCT/ES2023/070129

§ 371 Date: Sep. 9, 2024

(30) Foreign Application Priority Data
Mar. 10, 2022 (ES) P202230194

(51) Int. Cl. B02C 4/32; B02C 4/02

(52) U.S. Cl. CPC B02C 4/32; B02C 4/02

(57) ABSTRACT

The invention relates to a pre-shredder machine including an upper mechanism, with an upper shaft including at least one upper sprocket, and a lower mechanism, with a lower shaft including at least one lower sprocket. The pre-shredder includes at least one linear actuator and at least one of the mechanisms is movable, being joined to the chassis of the pre-shredder through a hinged attachment and to the linear actuator through a floating joint, so that the distance between the shafts is variable.

### CROSS-REFERENCE TO RELATED APPLICATIONS

This application is the United States national phase of International Patent Application No. PCT/ES2023/070129 filed Mar. 9, 2023, and claims priority to Spanish Patent Application No. P202230194 filed Mar. 10, 2022, the disclosures of which are hereby incorporated by reference in their entireties.

### BACKGROUND OF THE INVENTION

### Field of the Invention

The present invention relates to a pre-shredder, responsible for crushing material before being sent to a shredder, so that the shreds are more uniform and smaller in size. The particularity of the invention consists of the fact that the distance between the shafts of the pre-shredder is variable, so that it can be selected to obtain a specific size of shredded material.

### Description of Related Art

The material shredding process is one that requires a high demand for installed capacity, due to the large transformation required from the end-of-life stage of metal products until becoming shredded scrap for recycling. The machine that performs this process is called a shredder.

Document ES-2488040_B1 describes a shredder of those known in the state of the art with the peculiarity of being mobile, so that it is not necessary to have a shredding plant in the same place where the material is processed. This mobile shredder has a special application in an industry such as end-of-life vehicle recovery, where the shredding process is essential and, at the same time, because it is mobile, it can be shared in other facilities.

The power required by a shredder plant or a mobile shredder is reduced with the installation of a pre-shredder that previously processes the material that will be fed to said shredder and delimits, to a greater or lesser extent, the size and type of material that reaches the feed of the shredder.

This fact also means that the maintenance of the machinery in the two processes is less, that maintenance can be done in a more predictive way, that wear is less and that safety is increased, since various elements, which would cause explosions in the high-speed process in the shredder, can be processed at a low speed by the pre-shredder, in such a way that the risks of explosions in the shredder are reduced.

The characteristic that determines the caliber of the pre-shredder is the separation between the shafts for crushing and the gap between discs, called clearance. With the aim of minimizing the aforementioned risks, different types of pre-shredders can be selected depending on the clearance and with different material processing.

There are mainly two types of pre-shredders existing in the current state of the art.

On the one hand, there are those in which the clearance between their different shafts and discs is very tight, virtually non-existent. In this case, the material processing is carried out in scissor fashion (the process is comparable to a scissor cutting process).

On the other hand, there are those in which the clearance between the different teeth and shafts is large and the material processing is carried out by shredding and tearing the material. In the latter, the risk that small dangerous elements can get through unprocessed is high.

Regarding the characteristics of each one, if those of the first type, i.e., those of the scissor-cut type, are fed with pressed packages, such packages are virtually unprocessable by machines of this type, or the time they have to dedicate to the processing of these pressed packages is so long that they make processing unprofitable. Regarding the manner of processing the material, pre-shredders of this type prioritize the material shearing effect. In such machines, the material is passed through blades the function of which is to cut the material, something that is not always achieved.

Regarding the machines of the second type, they prioritize the material shredding effect, with production prevailing over processing size. However, the number of small objects that pass through unprocessed is greater than in the former, which means an increased risk of explosions in the subsequent shredding process. For safe processing, with this type of shredder for shredding, additional visual inspection of the material intended to feed the shredder is necessary.

In this way, the choice of the pre-shredder is carried out depending on the type of material that is to be processed and the size of the processing that is to be carried out. This implies that, in the event of a change in the material to be processed or the processing to be carried out, it will necessary to acquire a new pre-shredder with the necessary requirements, which leads to an increase in implementation costs.

The present invention solves this problem, which has not been solved in the present state of the art, by means of a pre-shredder with the ability to vary the clearance depending on the material to be processed.

Document EP0740962 discloses a device that has two rotatable crusher rollers whereby one is movable and can be moved to a different height from the other fixed roller. An opening is simultaneously released in the machine stand to discharge the material which cannot be crushed. The ends of the movable roller are mounted in slide blocks which are displaceable in parallel slits in the machine stand. The slide blocks are guided by lift elements into a position where a steep plane containing the axes of the two rollers is formed with the movable roller lower.

Document EP2653227 discloses an invention that relates to a roller crusher having two generally parallel rotatable rollers separated by a gap, and a feeding arrangement for feeding material to the rollers. The roller crusher further comprising a base frame and a first and a second roller frame section, each of the first and second roller frames sections, being pivotably connected to the base frame and arranged for carrying one of the rollers in bearings arranged at opposed ends of each roller. The roller crusher also comprises at least one balancing cylinder extending between one of the roller frame sections and the base frame such that when the at least one balancing cylinder is activated, the interconnected roller frame sections will pivot relative to the base frame, thus adjusting the position of the rollers relative to the base frame.

Document U.S. Pat. No. 3,208,678 discloses a dual-pivoting, cradle type, roll crusher, comprising a base; a pair of cradles pivotally mounted on said base for movement toward and away from each other; a pair of crushing rolls, said rolls being fixed to respective shafts journaled for rotation, one in each of said cradles, and being in cooperative crushing engagement when said cradles are pivoted toward each other; drive means for rotating each of said rolls with respect to the other; means for rotating said cradles about their respective pivot connection's with the base; means to vary the crushing pressure exerted by the rolls; and means to compensate for wear on the crushing faces of the rolls while maintaining a substantially constant crushing pressure regardless of the size of material passing between the rolls.

### SUMMARY OF THE INVENTION

The present specification relates to a pre-shredder the configuration and design of which provide a greater capacity for both material processing and for production, while at the same time increasing the safety of the processing of dangerous elements.

In order to solve the problems of the state of the art, the pre-shredder of the present invention includes a system for regulating the distance between the material processing shafts, being able to go from a more open configuration to a more closed one and vice versa, depending on the type of material to be processed or its origin or the final size of the processed product.

Likewise, in order to quickly obtain the desired opening configuration, the pre-shredder comprises a control system that allows the regulation of the opening based on a series of previously defined parameters, obtaining different working configurations of the machine and thus being able to achieve: a greater capacity for material processing or greater production or an increase in the safety of the low-speed processing of dangerous elements, etc.

In this way, the machine can work with a closed configuration, obtaining greater material processing, which material will require less energy in its subsequent processing in the shredder and will prevent potentially explosive material from passing to the subsequent high-speed shredding process of the shredder. In this configuration, in the event that material arrives in the form of packages, it is possible to change to a slightly more open configuration, where this type of material can also be processed, maintaining increased security at all times when processing highly explosive material in the high-speed shredding process.

Another one of the advantages of the system of the invention consists of the fact that the opening can be regulated depending on the requirements of the motor. In this way, a less powerful motor can be installed and the material can be processed by alternating between different degrees of opening.

Therefore, with the pre-shredder of the invention, all material processing configurations can be carried out with a single piece of equipment, thus achieving greater operating versatility and universality.

In order to achieve the objectives and avoid the drawbacks mentioned above, the present invention describes a pre-shredder comprising an upper mechanism, with an upper shaft comprising at least one upper sprocket, and a lower mechanism, with a lower shaft comprising at least one lower sprocket.

The pre-shredder comprises at least one linear actuator and at least one of the mechanisms is attached to the chassis of the pre-shredder through an articulated attachment and to the linear actuator through a floating joint, with the other end of the linear actuator being attached to the chassis. It is thereby possible to vary the distance between the shafts.

The linkage can thereby be the upper mechanism, the lower mechanism, or both simultaneously. In the latter case, the pre-shredder can incorporate a second linear actuator, attached to the other mechanism in the same way as the first one already described. However, the pre-shredder can incorporate a single linear actuator where each of the ends is attached to one of the mechanisms, where with respect to the machine, the linear actuator may be unattached or attached through an intermediate area to provide greater stability.

### BRIEF DESCRIPTION OF THE DRAWINGS

The terms Fig., Figs., Figure, and Figures are used interchangeably in the specification to refer to the corresponding figures in the drawings.

To complete the description of the invention, and for the purpose of helping to make the features thereof more readily understandable, according to a preferred exemplary embodiment thereof, a set of drawings is included wherein, by way of illustration and not limitation, the following figures have been represented:

FIG. 1 depicts a side view of the pre-shredder in a closed position, that is, with the upper mechanism close to the lower mechanism.

FIG. 2 depicts a front view of the pre-shredder depicted in FIG. 1.

FIG. 3 depicts a sectional view of the pre-shredder depicted in FIG. 2 to show the sprockets for crushing therein.

FIG. 4 depicts a side view of the pre-shredder in an open position, that is, with the upper mechanism distanced from the lower mechanism.

FIG. 5 depicts a front view of the pre-shredder depicted in FIG. 4.

FIG. 6 depicts a sectional view of the pre-shredder depicted in FIG. 5 to show the sprockets for crushing therein.

FIG. 7 depicts a schematic embodiment of the upper and lower shafts with a series of sprockets.

A list of the references used in the figures is provided below:
1. Upper mechanism.
2. Lower mechanism.
3. Upper shaft.
4. Lower shaft.
5. Upper sprockets.
6. Lower sprockets.
7. Linear actuator.
8. Articulated attachment.
9. Floating joint.

### DESCRIPTION OF THE INVENTION

The pre-shredder of the invention comprises an upper mechanism (1) and a lower mechanism (2) which respectively comprise an upper shaft (3) and a lower shaft (4) where, in turn, there are assembled an upper sprocket (5) and a lower sprocket (6) for crushing.

At least one of the two mechanisms (1, 2) is articulated, in such a way that it allows its relative position to be varied with respect to the other. In order to vary the position of one of the mechanisms (1, 2) with respect to the other, the pre-shredder incorporates a linear actuator (7). This linear actuator (7) can be a pneumatic cylinder, a hydraulic cylinder, or any other known actuator in the state of the art.

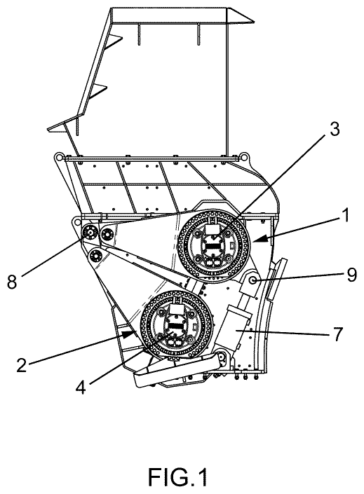

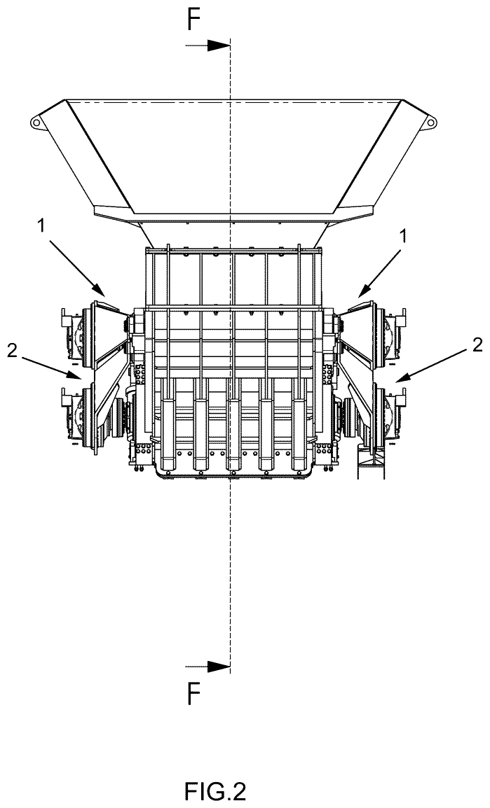

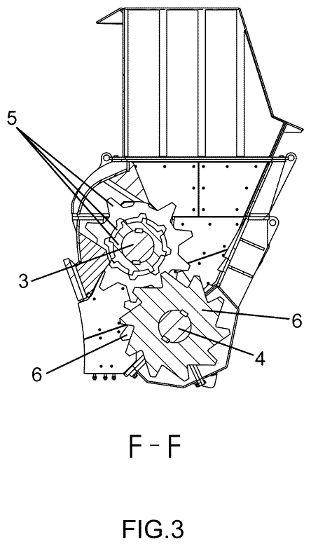

In a first embodiment of the invention, as depicted in FIGS. 1 to 3, the upper mechanism (1) is articulated.

To this end, the upper mechanism (1) consists of an articulated attachment (8) whereby it is joined to the chassis of the pre-shredder and a floating joint (9) articulated with respect to one end of a linear actuator (7), with the other end of the linear actuator (7) being attached to the chassis of the pre-shredder.

Control of the position of the linear actuator (7) is carried out by means of transducers.

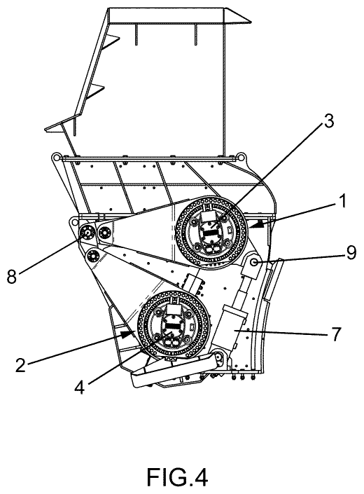

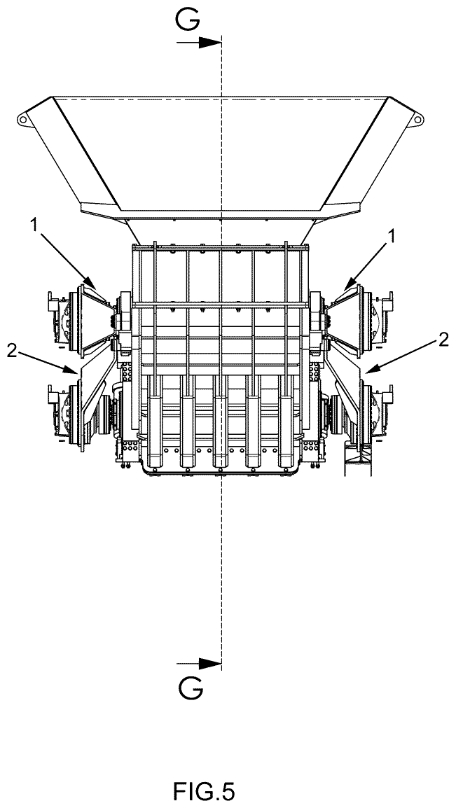

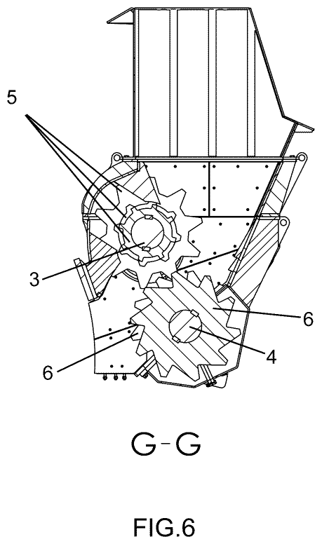

With this configuration, when the linear actuator (7) is activated, it moves the upper mechanism (1) with respect to the lower mechanism (2) through the floating joint (9), rotating around the articulated attachment (8) and thus varying the clearance between the upper shaft (3) and the lower shaft (4) and, therefore, the opening, since the upper sprockets (5) are more distanced from the lower sprockets (6), as depicted in FIGS. 4 to 6.

The upper shaft (3) is referred to as the slow shaft, because it rotates at a slower speed than the lower shaft (4). This differentiation in the speeds of the shafts (3, 4) is configured to be able to tear the material that passes between them. The slow shaft rotates at a speed of between 2 and 3 rpm while the fast shaft rotates at a speed of between 10 and 12 rpm.

In this way, the position of the linear actuator (7) can change the configuration of the pre-shredder by means of the separation between the shafts (3, 4) to be in an open position, closed position, or at an intermediate point, according to the needs of the process or material in a given situation.

In addition, there is the option of adjusting the degree of opening of the machine based on the power consumed in the process. This means that as long as specific motor load values are not exceeded, the pre-shredder will be in the closed position and, as the motor exceeds this specific value, the opening is modified proportionally, so that there is a better use of the motor. In any case, this option implies imperative situations since, for example, if the input material has a high content of explosive elements, the pre-shredder must work in the closed position.

In a second embodiment, the lower mechanism (2) is the articulated mechanism. The configuration of the pre-shredder would be the same as that shown in FIG. 1 with no further variations than turning the linear actuator (7) to position the floating joint (9) in the lower mechanism (2) and leave the upper mechanism (1) attached to the chassis of the pre-shredder as well as the other end of the linear actuator (7).

In a third embodiment, both the upper mechanism (1) and the lower mechanism (2) are articulated. This double articulation can be achieved either by using two linear actuators (7), one for each shaft, or by using a single linear actuator (7) joined to each mechanism (1,2) at each of its ends. In the latter case, the linear actuator (7) can be joined to the chassis of the pre-shredder through an intermediate area.

Only the first embodiment has been depicted in the figures, since the others are easy to understand in view of such figures.

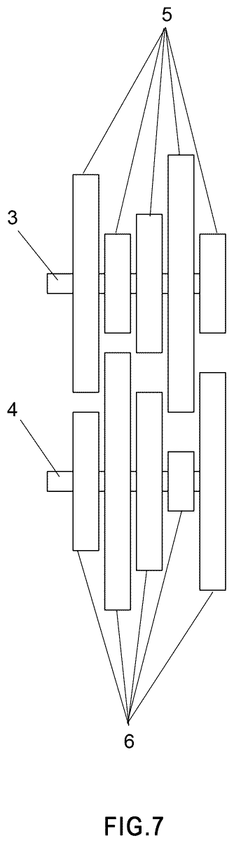

On the other hand, in order to take better advantage of the pre-shredder, each of the shafts (3, 4) can incorporate sprockets (5, 6) of different diameters, as depicted in the figures and schematically in FIG. 7 with greater detail. It is thereby possible tear material in two directions. The first is due to the interaction of the sprockets (5, 6) of the two shafts (3, 4) when facing one another. The second is caused by the shear force due to the movement between two non-facing, laterally contacting sprockets (5, 6). This configuration consists of combining sprockets (5, 6) with different diameters intercalated on the two shafts (3, 4) of the pre-shredder.

Lastly, it must be taken into account that the present invention must not be limited by the embodiment described herein. Other configurations may be carried out by those skilled in the art based on the present description. Accordingly, the scope of the invention is defined by the following claims.

1-7. (canceled)

8. A pre-shredder comprising an upper mechanism with an upper shaft comprising at least one upper sprocket and a lower mechanism with a lower shaft comprising at least one lower sprocket, wherein the pre-shredder comprises:
at least one linear actuator,
at least one of the mechanisms is mobile, being joined to the chassis of the pre-shredder through an articulated attachment and to the linear actuator through a floating joint,
so that the distance between the shafts is variable; and
a control system configured to regulate the distance between the shafts based on a series of previously defined parameters; and wherein the control system is configured to adjust the distance between the shafts based on a power consumed in the process.

9. The pre-shredder according to claim 8, wherein the upper mechanism is articulated.

10. The pre-shredder according to claim 8, wherein the lower mechanism is articulated.

11. The pre-shredder according to claim 8, wherein both the upper mechanism and the lower mechanism are articulated.

12. The pre-shredder according to claim 11, further comprising two linear actuators, with each linear actuator being linked to the upper mechanism or to the lower mechanism.

13. The pre-shredder according to claim 11, wherein the linear actuator is linked to the two mechanisms by both ends.

14. The pre-shredder according to claim 12, wherein the linear actuator is attached to the chassis of the pre-shredder.
